(19) United States
(12) Patent Application Publication
(10) Pub. No.: US 2004/0128126 A1
(43) Pub. Date: Jul. 1, 2004

(54) Preprocessing of digital audio data for mobile audio codecs

(76) Inventors: Young Han Nam, Seoul (KR); Seop Hyeong Park, Seoul (KR); Tae Kyoon Ha, Seoul (KR); Yun Ho Jeon, Seoul (KR)

Correspondence Address: Kenneth C. Booth, Schmeiser, Olsen & Watts LLP, 18 East University Drive, #101, Mesa, AZ, 85201, US

(21) Appl. No.: 10/686,389

(22) Filed: Oct. 14, 2003

(30) Foreign Application Priority Data
Oct. 14, 2002 (KR) 10-2002-0062507

(51) Int. Cl. G10L 19/14

(52) U.S. Cl. 704/225

(57) ABSTRACT

Recently, with the wider use of cellular phones, more and more users listen to music via their cellular phones, and thus, the sound quality of music provided via the cellular phones became more critical. Since music signals are encoded by a voice encoding method optimized to human voice signals such as EVRC (Enhanced Variable Rate Coding) in a cellular communication system, the music signals are often distorted by such encoding method, and listeners experience pauses in music caused by such voice-optimized encoding method. To improve the sound quality of music, a method for preprocessing audio data is provided in order to prevent the problem of pause in music signals in a cellular phone. In particular, AGC (Automatic Gain Control) preprocessing is performed to the audio data having low dynamic range. By this method, the number of pauses in music signal is reduced, and the sound quality of the music is improved.

### FIELD OF THE INVENTION

The present invention is directed to a method for preprocessing audio data in order to improve the quality of the music decoded at receiving terminals such as mobile phones; and more particularly, to a method for preprocessing audio data in order to mitigate a degradation to music signal that can be caused when the audio data is encoded/decoded in a wireless communication system using speech codecs optimized only for human voice signals.

### BACKGROUND OF THE INVENTION

The channel bandwidth of a wireless communication system is much narrower than that of a conventional telephone communication system of 64 kbps, and thus audio data in a wireless communication system is compressed before being transmitted. Methods for compressing audio data in a wireless communication system include QCELP (QualComm Code Excited Linear Prediction) of IS-95, EVRC (Enhanced Variable Rate Coding), VSELP (Vector-Sum Excited Linear Prediction) of GSM (Global System for Mobile Communication), PRE-LTP (Regular-Pulse Excited LPC with a Long-Term Predictor), and ACELP (Algebraic Code Excited Linear Prediction). All of these listed methods are based on LPC (Linear Predictive Coding). Audio compressing methods based on LPC utilize a model optimized to human voices and thus are efficient to compress voice at a low or middle encoding rate. In a coding method used in a wireless system, to efficiently use the limited bandwidth and to decrease power consumption, audio data is compressed and transmitted only when speaker's voice is detected by using what is called the function of VAD (Voice Activity Detection).

Recently, several services for providing music to wireless phone uses became available. One of which is what is called “Coloring service” which enables a subscriber to designate a tune of his/her choice so that callers who make a call to the subscriber would hear music instead of a traditional ringing tone while the subscriber is not answering the phone. Since this service became very popular first in Korea where it originated and then in other countries, transmission of music data to a cellular phone has been increasing. However, as explained above, the audio compression method based on LPC is suitable for human voice that has limited frequency components. When music or signals having frequency components in most of the audible frequency range (20˜20,000 Hz) are processed in a conventional LPC based codec and transmitted through a cellular phone, signal distortion occurs, which causes a pause in music or makes sound having only part of the original frequency components.

There are various reasons why the sound quality of audio data is degraded after audio data is compressed using audio codecs based on LPC, especially EVRC codecs. The sound quality degradation occurs in the following way.

(i) Complete loss of frequency components in a high-frequency bandwidth

(ii) Partial loss of frequency components in a low-frequency bandwidth

(iii) Intermittent pause of music

The first cause of the degradation cannot be avoided as long as the high-frequency components are removed using a 4 kHz (or 3.4 kHz) lowpass filter when audio data are compressed using narrow bandwidth audio codec.

The second phenomenon is due to the intrinsic characteristic of the audio compression methods based on LPC. According to the LPC-based compression methods, a pitch and a formant frequency of an input signal are obtained, and then an excitation signal for minimizing the difference between the input signal and the composite signal calculated by the pitch and the formant frequency of the input signal, is derived from a codebook. It is difficult to extract a pitch from a polyphonic music signal, whereas it is each in case of human voice. In addition, the formant component of music is very different from that of a person's voice. Consequently, it is expected that the prediction error signal for music data would be much larger than those of human speech signal, and thus many frequency components included in the original audio data are lost. The above two problems, that is, loss of high and low frequency components are due to inherent characteristic of audio codec optimized to voice signals, and inevitable to a certain degree.

The pauses in audio signal are caused by the variable encoding rate used by EVRC. An EVRC encoder processes the audio data with three rates (namely 1, ½, and ⅛). Among these rates, ⅛ rate means that the EVRC encoder determines that the input signal is a noise, and not a voice signal. Because sounds of a percussion instrument, such as a drum, include spectrum components that tend to be perceived as noises by audio codecs, music including this type of sounds is frequently paused. Also, audio codecs consider sounds having low amplitudes as noises, which also degrade the sound quality.

### SUMMARY OF THE INVENTION

The present invention provides a method for preprocessing audio signal to be transmitted via wireless system in order to improve the sound quality of audio data received at a receiving terminal of a subscriber. The present invention provides a method for mitigate the deterioration of music sound quality occurring when the music signal is processed by codes optimized for human voice, such as EVRC codecs. Another object of the present invention is to provide a method and system for preprocessing audio data in a way that does not interfere with the existing wireless communication system. Accordingly, the preprocessing method of the present invention is useful in that it can be used without modifying an existing system. The present invention can be applied in a similar manner to other codecs optimized for human voice other than EVRC as well.

In order to achieve the above object, the present invention provides a method for preprocessing audio data to be processed by a codec having variable coding rate, comprising the steps of:

classifying the audio data based on the characteristic of the audio data; and

preprocessing frames of audio data selected based on the classification.

In another aspect of the invention, a method for preprocessing audio data to be processed by a codec having variable coding rate is provided, which comprises the steps of:

classifying the audio data based on the characteristic of the audio data;

in case the audio data includes monophonic sound, performing AGC (automatic gain control) preprocessing of all frames; and

in case the audio data includes polyphonic sound, performing AGC preprocessing of selected frames.

According to a preferred embodiment of the present invention, AGC preprocessing of selected frames include deciding whether a frame in the audio data includes noise signal or not.

In yet another aspect of the invention, a method for preprocessing audio data to be processed by a codec having variable coding rate is provided, which comprises the steps of:

deciding an interval of audio data that is to be encoded in a low bit rate in said codec; and

adjusting the amplitude of audio data of the decided interval, such that the audio data in the interval may not be encoded in said low bit.

According to another preferred embodiment of the present invention, the adjusting step comprises the steps of:

calculating signal levels of the audio data;

deciding smoothed gain coefficients based on signal levels; and

generating preprocessed audio data by multiplying the smoothed gain coefficients to the audio data in the decided interval.

### DESCRIPTION OF THE DRAWINGS

The above object and features of the present invention will become more apparent from the following description of the preferred embodiments given in conjunction with the accompanying drawings.

FIG. 1 is a block diagram of an EVRC encoder.

FIG. 2A is a graph showing a frame residual signal for a signal having a dominant frequency component.

FIG. 2B is a graph showing a frame residual signal for a signal having a variety of frequencies.

FIG. 3A is a graph showing autocorrelation of residual for a signal having a dominant frequency component.

FIG. 3B is a graph showing autocorrelation of residual for a signal having a variety of frequencies.

FIG. 4 is a flow chart for performing AGC (Automatic Gain Control) preprocessing according to the present invention.

FIG. 5 is a flow chart for performing frame-selective AGC preprocessing according to the present invention.

FIG. 6 is a block diagram for performing AGC according to the present invention.

FIG. 7 is a graph showing a sampled audio signal and its signal level.

FIG. 8 is a graph for explaining the calculation of a forward-direction signal level according to the present invention.

FIG. 9 is a graph for explaining the calculation of a backward-direction signal level according to the present invention.

FIGS. 10A-10D are graphs showing results of AGC preprocessing.

### DETAILED DESCRIPTION OF THE INVENTION

As a way to solve the problem of intermittent pauses, the present invention provides a method of preprocessing audio data before it is subject to audio codec. Certain type of sounds (such as one of a percussion instrument) include spectrum components that tend to be perceived as noises by audio codecs optimized for human voice (such as codes for wireless system), and audio codecs consider the portions of music having low amplitudes as noises. This phenomenon is shown commonly in all systems employing DTX (discontinuous transmission) based on VAD (Voice Activity Detection) such as GSM (Global System for Mobile communication). In case of EVRC, if data is determined as noise, that data is encoded with a rate ⅛ among the three predetermined rates of ⅛, ½ and 1. The music data is decided as noise by the encoding system, the transmitted data basically cannot be heard at the receiving end, thus severely deteriorating the quality of sound.

This problem can be solved by preprocessing audio data so that the encoding rates of EVRC codec may be decided as 1 (and not ⅛) for frames of music data. According to the present invention, the encoding rate of music signals can be increased through preprocessing, and therefore, the pauses of music at the receiving terminal caused by EVRC are reduced. Although the present invention is explained with regard to EVRC codec, a person skilled in the art would be able to apply the present invention to other compression system using variable encoding rate, especially a codec optimized for human voice (such as an audio codec for wireless transmission).

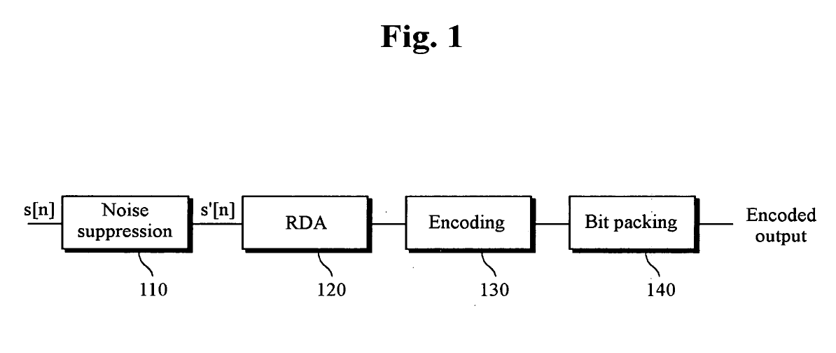

With reference to FIG. 1, RDA (Rate Decision Algorithm) of EVRC will be explained. EVRC will be explained as an example of a compression system using a variable encoding rate for compressing a data to be transmitted via wireless network where the present invention can be applied. Understanding of the rate decision algorithm of the conventional codec used in a existing system is important because the present invention is based on an idea that, in a conventional codec, some music data may be encoded at a data rate that is too low for music data (though maybe adequate for voice data), and by increasing the data rate for the music data, the quality of the music after the coding, transmission and decoding can be improved.

FIG. 1 is a high-level block diagram of an EVRC encoder. In FIG. 1, an input may be an 8 k, 16 bit PCM (Pulse Code Modulation) audio signal, and an encoded output may be digital data whose size can be 171 bits (when the encoding rate is 1), 80 bits (when the encoding rate is ½), 16 bits (when the encoding rate is ⅛), or 0 bit (blank) per frame according to the encoding rate decided by the RDA. The 8 k, 16 bit PCM audio is coupled to the EVRC encoder in units of frames where each frame has 160 samples (corresponding to 20 ms). The input signal s[n] (i.e. an nₜₕ input frame signal) is coupled to a noise suppression block 110, which checks the input frame signal s[n]. In case the input frame signal is considered noise in the noise suppression block 160, it multiplies a gain less than 1 to the signal and thereby suppresses the input frame signal. And then, s′[n] (i.e. a signal which has passed through the block 110) is coupled to an RDA block 120, which selects one rates from predefined set of encoding rates (1, ½, ⅛, and blank in the embodiment explained here). An encoding block 130 extracts proper parameters from the signal according to the encoding rate selected by the PDA block 120, and a bit packing block 140 packs the extracted parameters to conform to a predetermined output format.

As shown in the following table, the encoded output can have 171, 80, 16 or 0 bits per frame depending on the encoding rate selected by RDA.

TABLE 1

| Frame type | Bits per frame |
|---|---|
| Frame with encoding rate 1 | 171 |
| Frame with encoding rate ½ | 80 |
| Frame with encoding rate ⅛ | 16 |
| Blank | 0 |

The RDA block 120 divides s′[n] into two bandwidths (f(1) of 0.3˜2.0 kHz and f(2) of 2.0˜4.0 kHz) by using a bandpass filter, and selects the encoding rate for each bandwidth by comparing an energy value of each bandwidth with a rate decision threshold decided by a Background Noise Estimate (“BNE”). The following equations are used to calculate the two thresholds for f(1) and f(2).

T₁=k₁(SNR_{f(i)}(m−1))B_{f(i)}(m−1) Eq. (1a)

T₂=k₂(SNR_{f(i)}(m−1))B_{f(i)}(m−1) Eq. (1b)

Wherein k₁ and k₂ are threshold scale factors, which are functions of SNR (Signal-to-Noise Ratio) and increase as SNR increases. Further, B_{f(i)}(m−1) is BNE (background noise estimate) for f(i) band in the (m−1)ₜₕ frame. As described in the above equations, the rate decision threshold is decided by multiplying the scale coefficient and BNE, and thus proportional to BNE.

On the other hand, the band energy may be decided by 0^{th} to 16^{th} autocorrelation coefficients of audio data belonging to each frequency bandwidth.

$${BE}_{f ( i )} = {R}_{w} ( 0 ) {R}_{f ( i )} ( 0 ) + 2.0 {\sum }_{k = 1}^{{L}_{h} - 1} {R}_{w} ( k ) {R}_{f ( i )} ( k ) \qquad Eq . ( 2 )$$

Wherein BE_{f(i)} is an energy value for iₜₕ frequency bandwidth (i=1, 2), R_{w}(k) is a function of autocorrelation coefficients of input audio data, and R_{f(i)}(k) is an autocorrelation coefficient of an impulse response in a bandpass filter. Lₕ is a constant of 17.

Then, the update of an estimated noise (B_{f(i)}(m−1)) will be explained. The estimated noise (B_{f(i)}(m)) for iₜₕ frequency band (or f(i)) of mₜₕ frame is decided by the estimated noise (B_{f(i)}(m−1)) for f(i) of (m−1)ₜₕ frame, smoothed band energy (E^{SM}_{f(i)}(m)) for f(i) of mₜₕ frame, and a signal-to-noise ratio (SNR_{f(i)}(m−1)) for f(i) of (m−1)ₜₕ frame, which is represented in the pseudo code.

```
if ( [symbol] < 0.30 for 8 or more consecutive frames)
  B_{f(i)}(m)=min{E^{sm}_{f(i)}(m), 80954304, max{1.03B_{f(i)}(m−1),
  B_{f(i)}(m−1)+1}}
else{
  if (SNR_{f(i)}(m−1) > 3)
    B_{f(i)}(m)=min{E^{SM}_{f(i)}(m), 80954304, max{1.0054B_{f(i)}(m−1),
    B_{f(i)}(m−1)+1}}
  else
    B_{f(i)}(m)=min{E^{SM}_{f(i)}(m), 80954304, B_{f(i)}(m−1)}
  }
  if (B_{f(i)}(m) < lownoise(i))
  B_{f(i)}(m) = lownoise(i)
}
```

As described above, if the value of □, a long-term prediction gain (how to decide □ will be explained later) is less than 0.3 for more than 8 frames, the lowest value among (i) the smoothed band energy, (ii) 1.03 times of the BNE of the prior frame, and (iii) a predetermined maximum value of a BNE (80954304 in the above) is selected as the BNE. Otherwise (if the value of □ is not less than 0.3 in any of the 8 consecutive frames), if SNR of the prior frame is larger than 3, the lowest value among (i) the smoothed band energy, (ii) 1.00547 multiplied by BNE of the prior frame, and (iii) a predetermined maximum value of a BNE is selected as the BNE for this frame. If SNR of the prior frame is not larger than 3, the lowest value among (i) the smoothed band energy, (ii) the BNE of the prior frame, and the predetermined maximum value of BNE is selected as the BNE for this frame.

Therefore, in case of an audio signal, the BNE tends to increases as time passes, for example, by 1.03 times or by 1.00547 times from frame to frame, and decreases only when the BNE becomes larger than the smoothed band energy. Accordingly, if the smoothed band energy is maintained within a relatively small range, the BNE increases as time passes, and thereby the value of the rate decision threshold increases (see Eq. (1)). As a result, it becomes more likely that a frame is encoded with a rate of ⅛. In other words, if music signal is played for a long time, pauses tend to occur more frequently.

The long-term prediction gain (□) is defined by autocorrelation of residuals as follows.

$$β = max \{ o , min \{ 1 , \frac{{R}_{max}}{{R}_{ϵ} ( 0 )} \} \} \qquad Eq . ( 3 )$$

Wherein □ is a prediction residual signal, Rₘₐₓ is a maximum value of the autocorrelation coefficients of the prediction residual signal, and R_{□}(0) is a 0ₜₕ coefficient of an autocorrelation function of the prediction residual signal.

According to above equation, in case of monophonic signal or a voice signal where a dominant pitch exists, the value of □ would be larger, but in case of music including several pitches, the value of □ would be smaller.

The prediction residual signal (□) is defined as follows:

$$ϵ [ n ] = {s}^{′} [ n ] - {\sum }_{i = 1}^{10} {a}_{i} [ k ] {s}^{′} [ n - i ] \qquad Eq . ( 4 )$$

wherein s′[n] is an audio signal preprocessed by the noise suppression block 110, and aᵢ[k] is an interpolated LPC coefficient of the kₜₕ segment of a current frame.

That is, the prediction residual signal is a difference between a signal reconstructed by the LPC coefficients and an original signal.

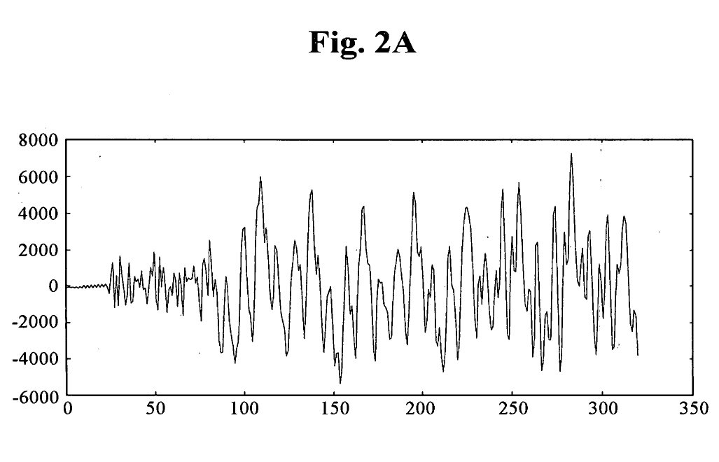

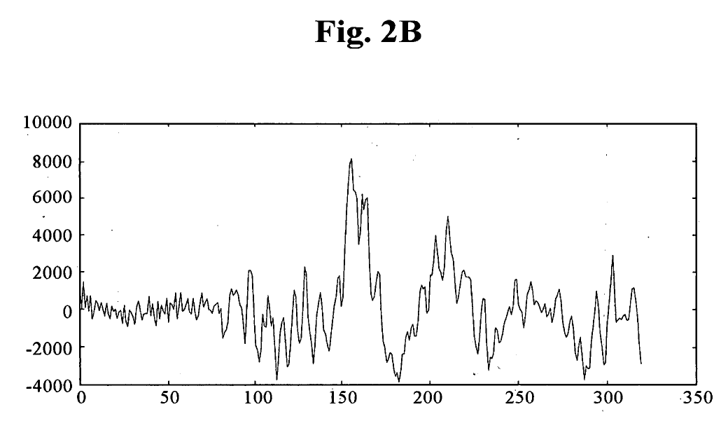

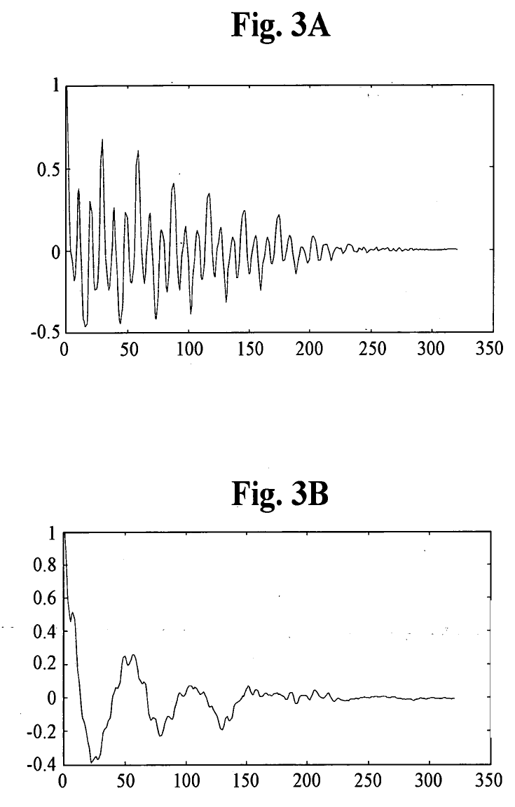

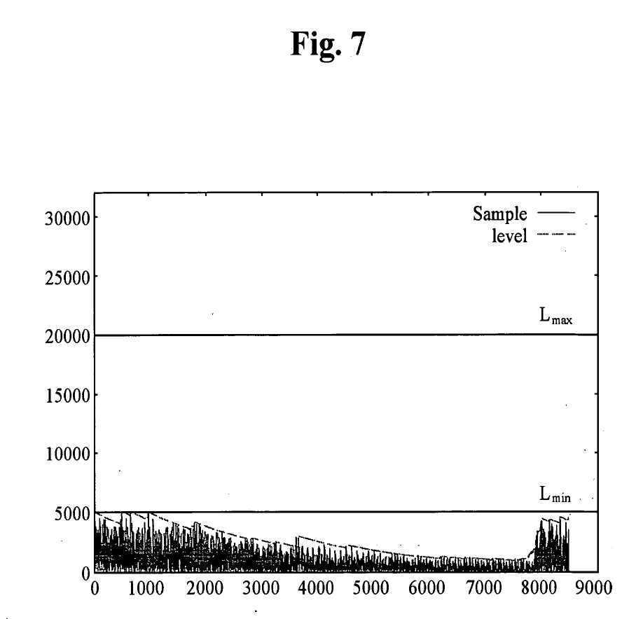

The frame residual signal looks regular in case there exists a dominant frequency component in the frame (see FIG. 2A), while it is irregular in case there exist various frequency components in the frame (see FIG. 2B). Accordingly, in the former case, a regulated maximum peak value of autocorrelation coefficients (that is long-term prediction gain □) would become a larger value (such as □=0.6792, see FIG. 3A), while in the latter case, it becomes a smaller value (such as □=0.2616, see FIG. 3B). In these FIGS. 3A and 3B, the autocorrelation coefficients are normalized by R(0). In FIGS. 2A and 2B, x-axis represents sample numbers and y-axis represents the amplitude of signal residual where the numbers on the graph are values normalized depending on the system requirement (for example, how many bits are used to represent the value), which applies to other graphs in this application (such as FIGS. 7-10).

How to decide the encoding rate will be explained. For each of the two frequency bands, if the band energy is higher than the two threshold values, the encoding rate is 1, if the band energy is between the two threshold values, the encoding rate is ½, and if the band energy is lower than both of the two threshold values, the encoding rate is ⅛. After encoding rates are decided for two frequency bands, the higher of two encoding rates decided for the frequency bands is selected as an encoding rate for that frame. In an actual system, coding at a rate of ⅛ may mean that the relevant signal is decided as noise and very little data is transmitted; coding at a rate of 1 may mean that the signal is decided as valid human voice; and coding at a rate of ½ happens for a short interval during the transition between ⅛ and 1.

Up to now, it was explained how the encoding rate is decided in an EVRC codec, which is an example of variable rate coding system where the present invention can be applied. From the foregoing, it can be understood that the encoding rate of a frame can be maximized to 1 as much as possible by (i) increasing the band energy and/or (ii) decreasing the threshold value for the encoding rate decision.

The present invention uses an AGC (Automatic Gain Control) method for increasing the band energy. AGC is a method for adjusting current signal gain by predicting signals for a certain interval (ATTACK interval). For example, if music is played in speakers having different dynamic ranges, it cannot be processed properly without AGC (without AGC, some speakers will operate in the saturation region.) Therefore, it is necessary to perform AGC preprocessing based on the characteristic of the sound generating device, such as a speaker, an earphone, or a cellular phone.

In case of a cellular phone, while it will be ideal to measure the dynamic range of the cellular phone and perform AGC in order to ensure best sound quality, it is impossible to design AGC optimized for all cellular phones because the characteristic of a cellular phone would vary depending on a manufacturer and also on particular model. Therefore, it is necessary to design an AGC generally applicable to all cellular phones.

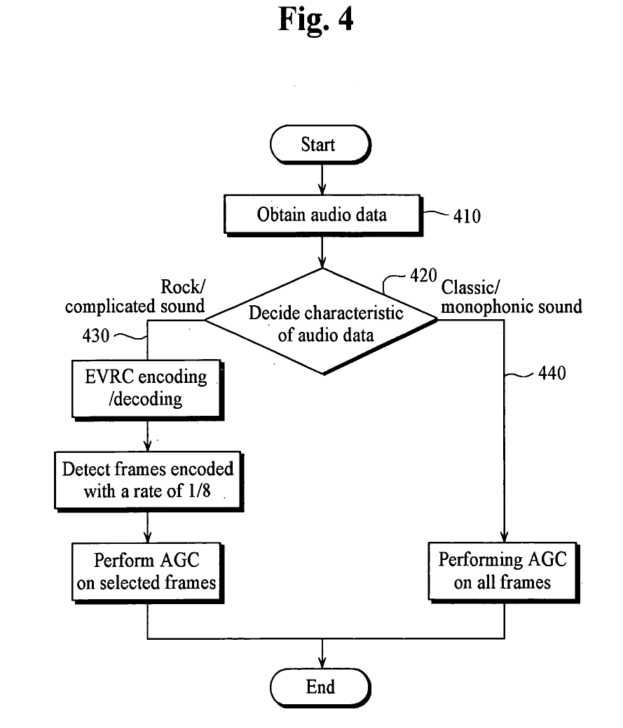

FIG. 4 is a high-level flow chart for performing AGC preprocessing according to one embodiment of the present invention. At first, audio data are obtained in step 410, and then the audio data is classified based on the characteristic of the audio data in step 420. The audio data would be processed in different ways depending on the classification because, for certain type of audio data, it is preferable to enhance the energy of all frames, while in other cases, it works better to enhance only the band energy of frames that are encoded with a low frame rate in the variable coding rate encoder (such EVRC). The right part 440 of the flow chart shows enhancement of energy of all frames. In case of classical music or monophonic audio data having one pitch, it is preferable that the right part 440 of the flow chart is performed. The left part 430 of the flow chart shows enhancing the band energy of such frames that are encoded with a low frame rate. In case of polyphonic audio data, such as rock music, it is preferable that the right part 430 of the flow chart is performed.

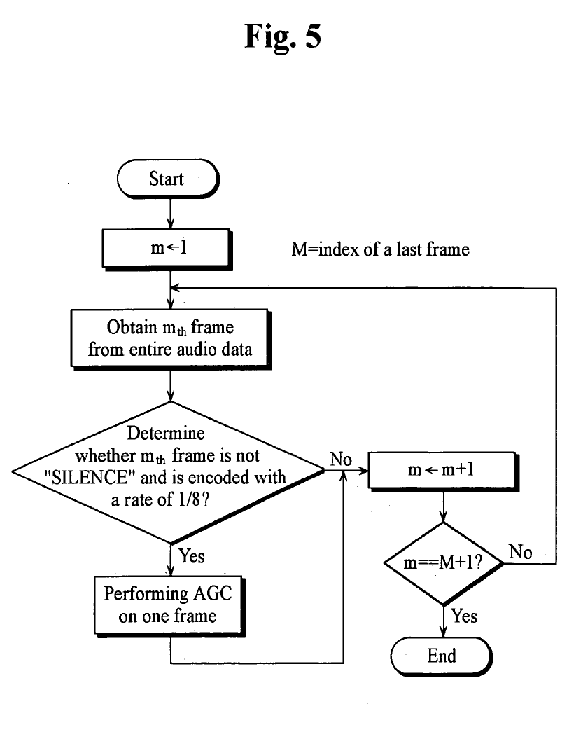

FIG. 5 is a flow chart for the frame-selective AGC for preprocessing frames that would be encoded with low rate without the preprocessing. AGC is performed in different ways depending on the energy of frames of music signals. The interval in which the energy of frames of the audio data (before the EVRC coding) is low (i.e. lower than 1,000) is defined as a “SILENCE” interval where no preprocessing is performed. For the frames not in the “SILENCE” interval, EVRC encoding is pre-performed to detect the encoding rate for each frame. For such intervals where the frames having encoding rate of ⅛ occur frequently (which means such intervals are considered a noise by EVRC encoder), the band energy of the frames is locally increased. When enhancing the energy for certain frames, interpolation with other frames would be necessary (in this regard, what is referred to “envelop interpolation” will be explained later) to prevent discontinuity of sound amplitude between the enhanced frames and non-enhanced neighboring frames.

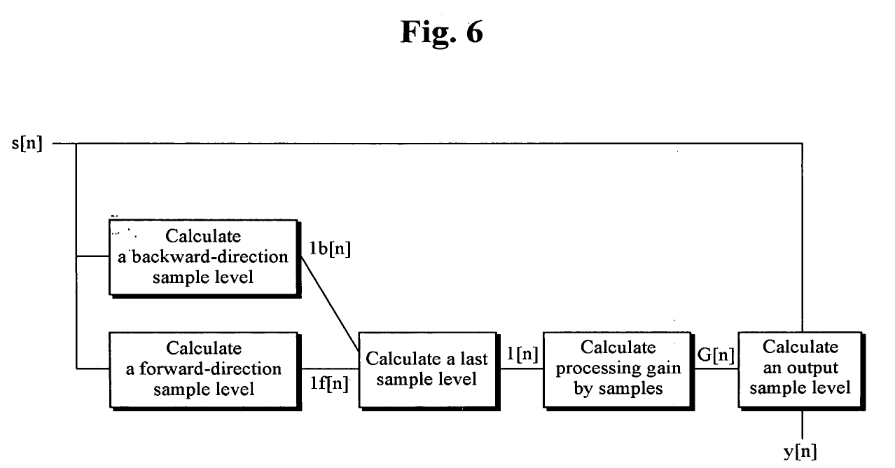

FIG. 6 is a block diagram for AGC in accordance with one embodiment of the present invention. In this embodiment, AGC is a process for adjusting the signal level of the current sample based on a control gain decided from a set of sample values in look-ahead window. At first, a “forward-direction signal level”. l_{f}[n] and a “backward-direction signal level” l_{b}[n] are calculated using the sampled audio signal s[n] in a way explained later, and from them, a “final signal level” l[n] is calculated. After l[n] is calculated, processing gain per sample (G[n]) is calculated using l[n], and then output y[n] is obtained by multiplying G[n] and s[n].

In the following, the functions of the blocks in FIG. 6 will be described in more detail.

FIG. 7 shows an exemplary signal level (l[n]) calculated from the sampled audio signal (s[n]). The envelope of the signal level l[n] varies depending on how to process signals by using forward-direction exponential suppression (“ATTACK”) and backward direction exponential suppression (“RELEASE”). In FIG. 7, Lₘₐₓ and Lₘᵢₙ refer to the maximum and minimum values of the output signal after the AGC preprocessing.

A signal level at time n is obtained by calculating forward-direction signal levels (for performing RELEASE) and calculating backward-direction signal levels (for performing ATTACK.) Time constant of an “exponential function” characterizing the exponential suppression will be referred to as “RELEASE time” in the forward-direction and as “ATTACK time” in the backward-direction. ATTACK time is a time taken for a new output signal to reach a proper output amplitude. For example, if an amplitude of an input signal decreases by 30 dB abruptly, ATTACK time is a time for an output signal to decrease accordingly (by 30 dB). RELEASE time is a time to reach a proper amplitude level at the end of an existing output level. That is, ATTACK time is a period for a start of a pulse to reach a desired output amplitude whereas RELEASE time is a period for an end of a pulse to reach a desired output amplitude.

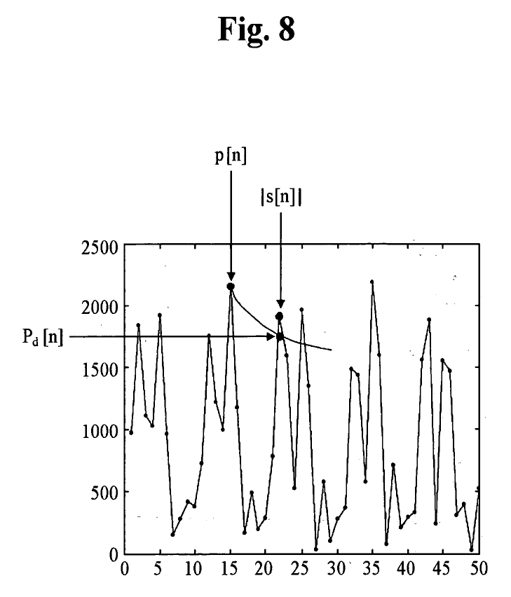

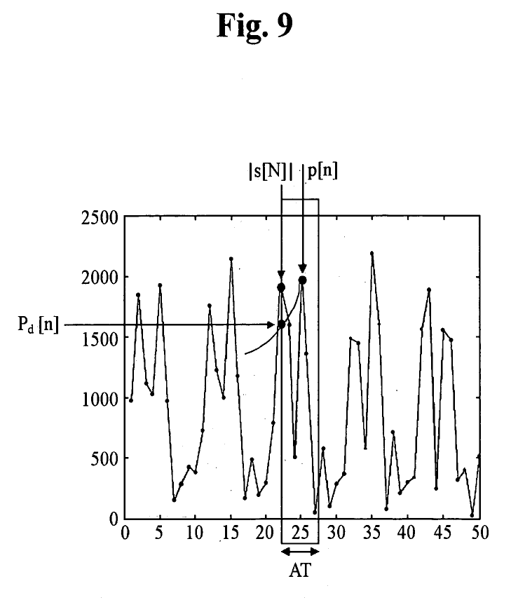

In the following, how to calculate a forward-direction signal level and a backward-direction signal level will be described with reference to FIGS. 8 and 9.

With reference to FIG. 8, a forward-direction signal level is calculated by the following steps.

In the first step, a current peak value and a current peak index are initialized (set to 0), and a forward-direction signal level (l_{f}[n]) is initialized to |s[n]|, an absolute value of s[n].

In the second step, the current peak value and the current peak index are updated. If |s[n]| is higher than the current peak value (p[n]), p[n] is updated to |s[n]|, and the current peak index (iₚ[n]) is updated to n (as shown in the following pseudo code.)

if (|s[n]|>p[n]) {

p[n]=|s[n]|

iₚ[n]=n

In the third step, a suppressed current peak value is calculated. The suppressed current peak value p_{d}[n] is decided by exponentially reducing the value of p[n] according to the passage of time as follows.

p_{d}[n]=p[n]*exp(−TD/RT)

TD=n−iₚ[n] Eq. (5)

Wherein RT stands for RELEASE time.

In the fourth step, a larger values out of p_{d}[n] and |s[n]| is decided as a forward-direction signal level, as follows.

l_{f}[n]=max(p_{d}[n], |s[n]|) Eq. (6)

Next, the above second to fourth steps are repeated to obtain a forward-direction signal level (l_{f}[n]) as n increases by one at a time.

With reference to FIG. 9, a backward-direction signal level is calculated by the following steps.

In the first step, a current peak value is initialized into 0, a current peak index is initialized to AT, and a backward-direction signal level (l_{b}[n]) is initialized to |s[n]|, an absolute value of s[n].

In the second step, the current peak value and the current peak index are updated. A maximum value of s[n] in the time window from n to n+AT is detected and the current peak value p(n) is updated as the detected maximum value. Also iₚ[n] is updated as the time index for the maximum value.

p[n]=max({|s[ ]|})

Iₚ[n]=(an index of s[ ], where |s[ ]| has its maximum value) Eq. (7)

Wherein the index of s[ ]can have values from n to n+AT.

In the third step, a suppressed current peak value is calculated as follows.

p_{d}[n]=p[n]*exp(−TD/AT)

TD=iₚ[n]−n Eq.(8)

Wherein AT stands for ATTACK time.

In the fourth step, a larger value from p_{d}[n] and |s[n]| is decided as a backward-direction signal level.

l_{b}[n]=max(p_{d}[n], |s[n]|) Eq. (9)

Next, the above second to fourth steps are repeated to obtain a backward-direction signal level (l_{b}[n]) as n increases by one at a time.

The final signal level (l[n]) is defined as a maximum value of the forward-direction signal level and the backward-direction signal level for each time index.

l[n]=max(l_{f}[n], l_{b}[n]) for t=0, . . . , tₘₐₓ Eq. (10)

Wherein tₘₐₓ is a maximum time index.

ATTACK time/RELEASE time is related to the sound quality/characteristic. Accordingly, when calculating signal levels, it is necessary to set ATTACK time and RELEASE TIME properly so as to obtain sound optimized to the characteristic of a media. If the sum of ATTACK time and RELEASE time is too small (i.e. the sum is less than 20 ms), a distortion in the form of vibration with a frequency of 1000/(ATTACK time+RELEASE time) can be heard to a cellular phone user. For example, if ATTACK time and RELEASE time are 5 ms each, a vibrating distortion with a frequency of 100 Hz can be heard. Therefore, it is necessary to set the sum of ATTACK time and RELEASE time longer than 30 ms so as to avoid vibrating distortion.

For example, if ATTACK is slow and RELEASE is fast, sound with wider dynamic range would be obtained. When RELEASE time is long, the high frequency component of output signal is suppressed the resulting signal sound dull. However, if RELEASE time becomes very fast (meaning of being “fast” in this regard may vary depending on the characteristic of music), in the output signal processed by AGC follows the low frequency component of the input waveform. In this case, the fundamental component of the signal is suppressed or may even be substituted by a certain harmonic distortion (the fundamental component means the most important frequency component that a person can hear, which is same as a pitch.) As ATTACK and RELEASE times become longer, pauses are well prevented but the sound become dull (loss of high frequency). Accordingly, there is a trade-off between the sound quality and the number of pauses.

To emphasize the effect of a percussion instrument, such as a drum, ATTACK time should be lengthened. However, in case of a person's voice, shortening ATTACK time would help in preventing the starting portion's gain from decreasing unnecessarily. It is important to decide ATTACK time and RELEASE time properly to ensure the sound quality in AGC processing, and they are decided considering the characteristic of music.

The preprocessing method of the present invention does not involve very complicated calculation and can be performed with very short delay (in the order of ATTACK and RELEASE time), and thus when broadcasting a music program, almost real-time preprocessing is possible.

As to which frames (or intervals) should be processed using the AGC in accordance with the present invention, it is preferable to process intervals with both low and high (compared to a certain standard) amplitude. When audio data having a wide dynamic range is encoded and transmitted in a wireless communication system and played by a cellular phone, the sound quality becomes degraded because the sound with low amplitudes tends not to be heard. Thus, for such frames with low amplitude, the amplitude should be increased for better quality signal. And, in case of interval (frames) with high amplitudes, the amplitude should be reduced to avoid the saturation of the sounds played. To achieve both goals, in one embodiment of the present invention, two limit values (Lₘᵢₙ and Lₘₐₓ) are set, and then the intervals, in which signal levels are lower than Lₘᵢₙ or higher than Lₘₐₓ, are processed.

As explained above, to avoid the sudden change in amplitude between the processed (by AGC) and not processed intervals, it is necessary to adjust the control gain properly to prevent abrupt change in amplitude. Also, after the AGC, the maximum level cannot exceed the maximum limit value (Lₘₐₓ), and therefore, without gain value smoothing, the envelope of music signals may be fixed at the maximum limit value. If the envelope is fixed to the maximum limit value, the sound quality of processed intervals would be different from that of non-processed intervals.

Considering the above, processing gain per each sample signals (G[n]) is decided by the following equation.

G[n]=c*(L/l[n])+(1−c) Eq. (11)

Wherein c is a gain coefficient, which has a value between 0 and 1. And, L is set to be Lₘᵢₙ or Lₘₐₓ depending on the characteristic of the signal in intervals to be processed.

The processed signal (s′[n]) is decided by a multiplication of the signal before AGC (s[n]) and the processing gain.

s′[n]=G[n]*s[n] Eq. (12)

From the above equations (Eq. 11 and Eq. 12) one can know that as c becomes closer to 1, the output envelope would be fixed to the limit value, and as c become closer to 0, the envelope of the resultant signal after AGC (using the gain in the above Equation) would become similar to the input envelope.

By using the method explained above, the encoding rate of music signals can be enhanced, and thereby the problem of music pause caused by EVRC can be sufficiently improved.

Experiment results regarding the above explained method will be explained. 8 kHz, 16 bit sampled monophonic music signals with CD quality are used in this experiment.

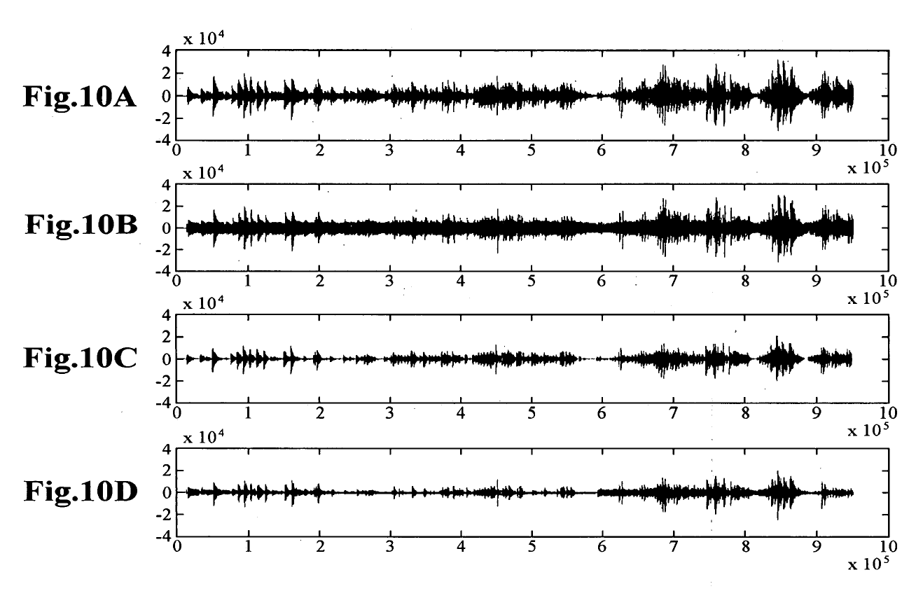

FIGS. 10A-10D show comparison between the coded signals in case of using AGC preprocessing of the present invention and in the case of not using the AGC preprocessing. In FIGS. 10A-10D, the horizontal axis is a time axis, and the vertical axis represent a signal amplitude. FIG. 10A shows the original signal, FIG. 10B shows AGC processed signal, FIG. 10C shows EVRC encoded signal from the original signals, and FIG. 10D shows EVRC encoded signal from the AGC preprocessed signals. In the signal having wide dynamic range as shown in FIG. 10A, more pauses tend to occur, especially for the period of low amplitude that would be considered noise. In FIG. 10C, one can note that signal with low amplitudes would not be heard. The original signal is AGC preprocessed using parameters in Table 2, and the preprocessed signal is shown in FIG. 10B. After EVRC coding/decoding, the AGC preprocessed signal becomes one in FIG. 10D. As shown in FIG. 10D, AGC preprocessing enhances the signal portion having low amplitude so that after EVRC coding/decoding the signal may not be paused. As shown in Table 3, through AGC preprocessing, the number of the frames encoded with an encoding rate of ⅛ decreases from 356 to 139.

TABLE 2

| | |
|---|---|
| ATTACK sample number | 160 |
| RELEASE sample number | 2000 |
| Minimum limit value | 5000 |
| Maximum limit value | 30000 |
| Gain smoothing coefficient | 0.5 |

TABLE 3

| | Original signals | AGC preprocessed signals |
|---|---|---|
| Number of frames with | 356 | 139 |
| an encoding rate of ⅛ | | |

MOS (mean opinion score) test to a test group of 11 people at the age of 20s and 30s has been performed for the comparison between original music and music preprocessed by the suggested AGC preprocessing algorithm. Samsung Anycall™ cellular phones are used for the test. Non-processed and preprocessed music signals had been encoded and provided to a cell phone in random sequence, and evaluated by the test group by using a five-grade scoring scheme as follows:

(1) bad (2) poor (3) fair (4) good (5) excellent

Three songs were used for the test, and Table 4 shows the result of the experiment. According to the test result, through AGC preprocessing, average points for the songs are increased from 3.000 to 3.273, from 1.727 to 2.455, and from 2.091 to 2.727.

TABLE 4

| Title of songs | Genre of | Average points for | Average points for |
|---|---|---|---|
| (Composer) | songs | original songs | preprocessed songs |
| Girl's Prayer | Piano Solo | 3.000 | 3.273 |
| (Badarczevska) | | | |
| Sonata Pathetic | Piano Solo | 1.727 | 2.455 |
| Op 13 | | | |
| (Beethoven) | | | |
| Fifth | Symphony | 2.091 | 2.727 |
| symphony | | | |
| (Fate) | | | |
| (Beethoven) | | | |

In one embodiment of the invention, conventional telephone and wireless phone may be serviced by one system for providing music signal. In that case, a caller ID is detected at the system for processing music signal. In a conventional telephone system, a non-compressed voice signal with 8 kHz bandwidth is used, and thus, if 8 kHz/8 bit/a-law sampled music is transmitted, music of high quality without signal distortion can be heard. In one embodiment of the invention, a system for providing music signal to user terminal determines whether a request for music was originated by a caller from a conventional telephone or a wireless phone, using a caller ID. In the former case, the system transmits original music signal, and in the latter case, the system transmits AGC preprocessed music.

It would be apparent to the person in the art that the pre-processing method of the present invention can be implemented by using either software or a dedicated hardware. Also, in one embodiment of the invention VoiceXLM system is used to provide music to the subscribers, where audio contents can be changed frequently. In such a system, AGC preprocessing of the present invention can be performed on-demand basis. To perform this, a non-standard tag, such as <audio src=“xx.wav” type=“music/classical/”>, can be defined to determine whether to perform preprocessing or types of preprocessing to be performed.

The application of the present invention includes any wireless service that provides music or other non-human-voice sound through a wireless network (that is, using a codec for a wireless system). In addition, the present invention can also be applied to another communication system where a codec used to compress the audio data is optimized to human voice and not to music and other sound. Specific services where the present invention can be applied includes, among others, “coloring service” and “ARS (Audio Response System).”

The pre-processing method of the present invention can be applied to any audio data before it is subject to a codec of a wireless system (or any other codec optimized for human voice and not music). After the audio data is preprocessed in accordance with the pre-processing method of the present invention, the pre-processed data can be processed and transmitted in a regular wireless codec. Other than adding the component necessary to perform the pre-processing method of the present invention, no other modification to the wireless system is necessary. Therefore, the pre-processing method of the present invention can be easily adopted by an existing wireless system.

Although the present invention is explained with respect to the EVRC codec, in other embodiment of the present invention, it can be applied in a similar manner to other codecs having variable encoding rate.

The present invention is described with reference to the preferred embodiments and the drawings, but the description is not intended to limit the present invention to the form disclosed herein. It should be also understood that a person skilled in the art is capable of using a variety of modifications and another embodiments equal to the present invention. Therefore, only the appended claims are intended to limit the present invention.

What is claimed is:

1. A method for preprocessing audio data to be processed by a codec having variable coding rate, comprising the steps of:
classifying the audio data based on the characteristic of the audio data; and
preprocessing frames of audio data selected based on the classification.

2. A method for preprocessing audio data to be processed by a codec having variable coding rate, comprising the steps of:
classifying the audio data based on the characteristic of the audio data;
in case the audio data includes monophonic sound, performing AGC (automatic gain control) preprocessing of all frames; and
in case the audio data includes polyphonic sound, performing AGC preprocessing of selected frames.

3. A method in accordance with claim 2, wherein the step of performing AGC preprocessing of selected frames include deciding whether a frame in the audio data includes noise signal or not.

4. A method for preprocessing audio data to be processed by a codec having variable coding rate, comprising the steps of:
deciding an interval of audio data that is to be encoded in a low bit rate in said codec; and
adjusting the amplitude of audio data of the decided interval, such that the audio data in the interval may not be encoded in said low bit.

5. A method in accordance with claim 4, wherein the adjusting step comprises the steps of:
calculating signal levels of the audio data;
deciding smoothed gain coefficients based on signal levels; and
generating preprocessed audio data by multiplying the smoothed gain coefficients to the audio data in the decided interval.

6. An apparatus for providing audio data encoded by a codec having variable encoding rate, comprising:
means for deciding an interval of audio data that is to be encoded in a low bit rate by said codec; and
means for adjusting the amplitude of audio data of the decided interval, such that the audio data in the interval may not be encoded in said low bit.
